(19) United States
(12) Patent Application Publication
(10) Pub. No.: US 2020/0311832 A1
(43) Pub. Date: Oct. 1, 2020

(54) GAS USE TIME LIMIT PUSHING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/366,925

(22) Filed: Mar. 27, 2019

(51) Int. Cl. G06Q 50/06; G06Q 10/08; G06Q 40/00

(52) U.S. Cl. CPC G06Q 50/06; G06Q 40/12; G06Q 10/087

(57) ABSTRACT

The present invention provides a gas usage time limit pushing method based on a compound Internet of Things (IoT) and an IoT system, and relates to the field of IoT. According to the method and the system provided by the present invention, after the gas is purchased, a usage time limit for the purchased gas can be estimated and is sent to a user platform to remind a user, so that the user can repurchase the gas before the purchased gas is used up, thereby improving the user experience.

### TECHNICAL FIELD

The present invention relates to the field of Internet of Things (IoT), and in particular to a gas usage time limit pushing method based on a compound IoT and an IoT system.

### BACKGROUND

Along with ever-changing development of an IoT technology, various instruments and meters, such as a gas meter, also enter the sector of an IoT. A traditional gas meter has been gradually replaced by an IoT intelligent gas meter.

In the process of gas usage, a gas user usually does not observe a use condition of the purchased gas at any time, resulting in a condition in which the gas may be stopped suddenly due to an insufficient gas balance when the user uses the gas and thus affecting the daily life of the user.

### SUMMARY

In view of this, an objective of the present invention is to provide a gas usage time limit pushing method based on a compound IoT and an IoT system to implement the effect that when the gas is purchased, a usage time limit of a corresponding gas meter can be estimated according to gas purchase information to remind a user.

To this end, the technical solutions adopted by the present invention are as follows:

According to a first aspect, the present invention provides a gas usage time limit pushing method based on a compound IoT; the method is applied to an IoT system; the IoT system comprises a plurality of object sub-platforms, a plurality of sensor network sub-platforms, a plurality of management sub-platforms, a service platform and a user platform; each of the object sub-platforms includes a gas meter; each of the sensor network sub-platforms includes an IoT intelligent gateway; the management sub-platforms include a gas company management server; and the method includes:

when a user recharges each gas meter via the user platform, respectively sending, by the service platform, recharge information of each gas meter to a corresponding management sub-platform;

sending, by each of the management sub-platforms, recharge information of a corresponding gas meter to the corresponding gas meter via a corresponding sensor network sub-platform;

updating, by each of the gas meters, a current account balance according to corresponding recharge information, and sending the current account balance to a corresponding management sub-platform via a corresponding sensor network sub-platform;

respectively obtaining, by each of the management sub-platforms, according to a current account balance and a gas usage model of a corresponding gas meter, a first gas remaining amount and a first gas usage time limit of the corresponding gas meter, and sending the first gas remaining amount and the first gas usage time limit of the corresponding gas meter to the service platform; and

sending, by the service platform, a first gas remaining amount and a first gas usage time limit of each of the gas meters to the user platform.

Further, the method includes:

when the user platform queries gas usage information of any gas meter from the service platform, obtaining, by a management sub-platform corresponding to the gas meter, a second gas remaining amount of the gas meter according to a current account balance of the gas meter, estimating a second gas remaining usage time limit of the gas meter according to a gas usage model of the gas meter, and sending the second gas remaining amount and the second gas remaining usage time limit of the gas meter to the service platform; and

sending, by the service platform, the second gas remaining amount and the second gas remaining usage time limit of the gas meter to the user platform.

Further, the method includes:

when a current account balance of a gas meter is smaller than a predetermined threshold, obtaining, by a management sub-platform corresponding to the gas meter, a third gas remaining amount of the gas meter according to a current account balance, estimating a third gas remaining usage time limit of the gas meter according to a gas usage model of the gas meter, and sending the third gas remaining amount and the third gas remaining usage time limit of the gas meter to the service platform; and sending, by the service platform, the third gas remaining amount and the third gas remaining usage time limit of the gas meter to a mobile terminal bound to the gas meter.

Further, the method includes:

updating, by each of the management sub-platforms, according to a current gas usage record of a corresponding gas meter, a gas usage model of the gas meter.

Further, the method includes:

when a current gas price changes, updating, by each of the management sub-platforms, a gas usage model of a gas meter according to the current gas price.

According to a second aspect, the present invention further provides an IoT system; the IoT system includes a plurality of object sub-platforms, a plurality of sensor network sub-platforms, a plurality of management sub-platforms, a service platform and a user platform;

when a user recharges each gas meter via the user platform, the service platform respectively sends recharge information of each gas meter to a corresponding management sub-platform;

each of the management sub-platforms sends recharge information of a corresponding gas meter to the corresponding gas meter via a corresponding sensor network sub-platform;

each of the gas meters updates a current account balance according to corresponding recharge information, and sends the current account balance to a corresponding management sub-platform via a corresponding sensor network sub-platform;

each of the management sub-platforms respectively obtains, according to a current account balance and a gas usage model of a corresponding gas meter, a first gas remaining amount and a first gas usage time limit of the corresponding gas meter, and sends the first gas remaining amount and the first gas usage time limit of the corresponding gas meter to the service platform; and

the service platform sends a first gas remaining amount and a first gas usage time limit of each of the gas meters to the user platform.

Further, when the user platform queries gas usage information of any gas meter from the service platform, a management sub-platform corresponding to the gas meter obtains a second gas remaining amount of the gas meter according to a current account balance of the gas meter, estimates a second gas remaining usage time limit of the gas meter according to a gas usage model of the gas meter, and sends the second gas remaining amount and the second gas remaining usage time limit of the gas meter to the service platform; and

the service platform sends the second gas remaining amount and the second gas remaining usage time limit of the gas meter to the user platform.

Further, when a current account balance of a gas meter is smaller than a predetermined threshold, a management sub-platform corresponding to the gas meter obtains a third gas remaining amount of the gas meter according to a current account balance, estimates a third gas remaining usage time limit of the gas meter according to a gas usage model of the gas meter, and sends the third gas remaining amount and the third gas remaining usage time limit of the gas meter to the service platform; and the service platform sends the third gas remaining amount and the third gas remaining usage time limit of the gas meter to a mobile terminal bound to the gas meter.

Further, each of the management sub-platforms updates, according to a current gas usage record of a corresponding gas meter, a gas usage model of the gas meter.

Further, when a current gas price changes, each of the management sub-platforms updates a gas usage model of a gas meter according to the current gas price.

Compared with the prior art, the gas usage time limit pushing method based on the compound IoT and the IoT system provided by the present invention have the following beneficial effects:

The present invention provides a gas usage time limit pushing method based on a compound IoT and an IoT system. The method includes: when a user recharges each gas meter via a user platform, respectively sending, by a service platform, recharge information of each gas meter to a corresponding management sub-platform; sending, by each of the management sub-platforms, recharge information of a corresponding gas meter to the corresponding gas meter via a corresponding sensor network sub-platform; updating, by each of the gas meters, a current account balance according to corresponding recharge information, and sending the current account balance to a corresponding management sub-platform via a corresponding sensor network sub-platform; respectively obtaining, by each of the management sub-platforms, according to a current account balance and a gas usage model of a corresponding gas meter, a first gas remaining amount and a first gas usage time limit of the corresponding gas meter, and sending the first gas remaining amount and the first gas usage time limit of the corresponding gas meter to the service platform; and sending, by the service platform, a first gas remaining amount and a first gas usage time limit of each of the gas meters to the user platform. According to the gas usage time limit pushing method based on the compound IoT and the IoT system provided by the present invention, after a user purchases the gas at each time, a usage time limit for the purchased gas of the user can be estimated and is sent to the user platform to remind the user, so that the user can repurchase the gas before the purchased gas is used up and a condition in which the gas is stopped suddenly because the purchased gas is used up in the process of gas usage of the user is effectively prevented, thereby facilitating the daily life of the user and improving the user experience.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention;

FIG. 2 illustrates a flowchart of a gas usage time limit pushing method based on a compound IoT provided by an embodiment of the present invention;

FIG. 3 illustrates a flowchart of step S104 in FIG. 2; and

FIG. 4 illustrates a flowchart of another gas usage time limit pushing method based on a compound IoT provided by an embodiment of the present invention.

Numerals in the drawings: 100—IoT system; 10—object sub-platform; 20—sensor network sub-platform; 30—management sub-platform; 40—service platform; 50—user platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

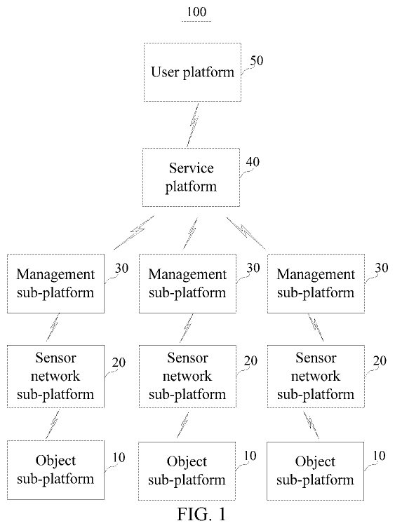

Referring to FIG. 1, a gas usage time limit pushing method based on a compound IoT provided by an embodiment of the present invention is applied to an IoT system. The IoT system 100 includes a plurality of object sub-platforms 10, a plurality of sensor network sub-platforms 20, a plurality of management sub-platforms 30, a service platform 40, and a user platform 50. Herein, the plurality of object sub-platforms 10 are respectively and communicatively connected with the plurality of management sub-platforms 30 via the plurality of sensor network sub-platforms 20 to respectively send relevant data of the corresponding object sub-platforms 10 to the plurality of management sub-platforms 30, or receive control signals sent by the corresponding management sub-platforms 30. The plurality of management sub-platforms 30 are communicatively connected with the service platform 40, and may push information to the service platform 40. In this embodiment of the present invention, each of the object sub-platforms 10 includes a gas meter; each of the sensor network sub-platform 20 includes an IoT intelligent gateway; the management sub-platforms 30 include a gas company management server; the service platform 40 includes a gas company operation server; and the user platform 50 includes a user terminal device (such as a gas recharge terminal of a supermarket or a residence community). The gas usage time limit pushing method based on the compound IoT provided by the embodiment of the present invention is used for estimating, when a user recharges via the service platform 40 to purchase the gas, a usage time limit of the gas, and intelligently pushing the usage time limit to remind the user, so that the user can repurchase the gas before the purchased gas is used up and a condition in which the gas is stopped suddenly because the purchased gas is used up in the process of gas usage of the user is prevented.

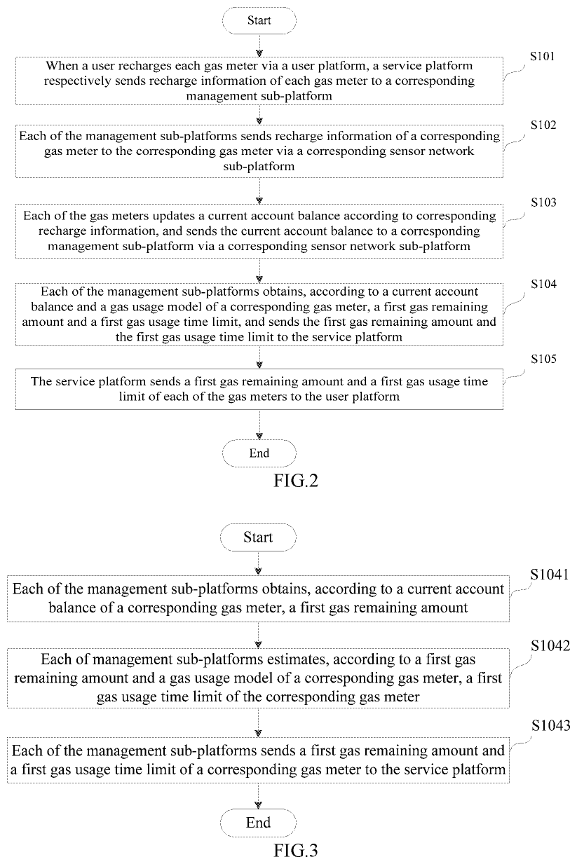

See FIG. 2, which illustrates a flowchart of a gas usage time limit pushing method based on a compound IoT provided by an embodiment of the present invention. The process shown in FIG. 2 is described below in detail.

Step S101, when a user recharges each gas meter via a user platform 50, a service platform 40 respectively sends recharge information of each gas meter to a corresponding management sub-platform 30.

In this embodiment of the present invention, each gas meter corresponds to one gas account, and gas accounts of different gas meters are managed by different management sub-platforms 30, i.e., each gas meter corresponds to one management sub-platform 30. Each user may log in/access the service platform 40 via the user platform to recharge the gas account, thus purchasing the gas (each gas meter corresponds to one gas account, and that the user recharging the gas account is described hereinafter as recharging the gas meter for the ease of understanding). For example, in a supermarket, a user logs in/accesses the service platform 40 via a gas recharge terminal of the supermarket to recharge a gas meter.

After a gas meter is recharged successfully via the service platform 40, the service platform 40 sends recharge information of each successfully recharged gas meter to a corresponding management sub-platform 30. For example, the gas meter A is managed by a management server of a gas company A, and the gas meter B is managed by a management server of a gas company B; after the gas meter A and the gas meter B are recharged by the service platform 40 successfully, the service platform 40 sends recharge information of the gas meter A to the management server of the gas company A, and sends recharge information of the gas meter B to the management server of the gas company B. The recharge information includes a recharge amount.

Step S102, each of the management sub-platforms 30 sends recharge information of a corresponding gas meter to the corresponding gas meter via a corresponding sensor network sub-platform 20.

A plurality of management sub-platforms 30 may be communicatively connected with a plurality of gas meters (object sub-platforms 10) via a plurality of sensor network sub-platforms 20. Specifically, each management sub-platform 30 may be communicatively connected with one gas meter via one sensor network sub-platform 20, communicatively connected with the same gas meter via the plurality of sensor network sub-platforms 20, simultaneously and communicatively connected with the plurality of gas meters via one sensor network sub-platform 20, or respectively and communicatively connected with the plurality of gas meters via the plurality of sensor network sub-platforms 20. As shown in FIG. 1, for the ease of understanding, in this embodiment of the present invention, each management sub-platform 30 is communicatively connected with one gas meter via one sensor network sub-platform 20.

After any gas meter is successfully charged via the service platform 40, a management sub-platform 30 corresponding to the gas meter sends recharge information of the gas meter to the gas meter via a corresponding sensor network sub-platform 20.

Step S103, each of the gas meters updates a current account balance according to corresponding recharge information, and sends the current account balance to a corresponding management sub-platform 30 via a corresponding sensor network sub-platform 20.

Upon the reception of recharge information sent by a corresponding management sub-platform 30, a gas meter updates a current account balance according to a recharge amount in the recharge information, and sends the updated account balance to a corresponding management sub-platform 30 via a corresponding sensor network sub-platform 20.

Further, in this embodiment of the present invention, after a gas meter updates a current account balance according to a recharge amount in the recharge information, it may further update a current gas remaining amount according to a current gas price, so that a user directly knows the current account balance and gas remaining amount of the gas meter according to a content displayed by the gas meter.

Step S104: each of the management sub-platforms 30 obtains, according to a current account balance and a gas usage model of a corresponding gas meter, a first gas remaining amount and a first gas usage time limit, and sends the first gas remaining amount and the first gas usage time limit to the service platform.

Specifically, step S104 includes the following sub-steps:

Sub-step S1041, each of the management sub-platforms 30 obtains, according to a current account balance of a corresponding gas meter, a first gas remaining amount.

Upon the reception of an updated account balance of a corresponding gas meter, each of the management sub-platforms 30 calculates, according to a current account balance (updated account balance) of the corresponding gas meter and the current gas price, a first gas remaining amount (i.e., current gas remaining amount) of the corresponding gas meter.

Sub-step S1042, each of management sub-platforms 30 estimates, according to a first gas remaining amount and a gas usage model of a corresponding gas meter, a first gas usage time limit of the corresponding gas meter.

Each of the management sub-platforms 30 records a history gas usage record of a corresponding gas meter, and establishes a gas usage model for estimating a gas remaining usage time limit of the gas meter according to the history gas usage record of the corresponding gas meter. Each of the gas usage models takes quantized parameters, such as a gas price, season, month and different dates of each week, as inputs and gives different weights to different parameters.

After first gas remaining amounts of corresponding gas meters are calculated, each of the management sub-platforms 30 estimates, according to a first gas remaining amount and a preliminarily established gas usage model of a corresponding gas meter, a first gas usage time limit of the corresponding gas meter.

Sub-step S1043, each of the management sub-platforms 30 sends a first gas remaining amount and a first gas usage time limit of a corresponding gas meter to the service platform 40.

After first gas remaining amounts and first gas usage time limits of corresponding gas meters are obtained, each of the management sub-platforms 30 sends a first gas remaining amount and a first gas usage time limit of a corresponding gas meter to the service platform 40. Each of the first gas usage time limits indicates a time limit within which the current purchased gas can be used normally if a user complies with a previous gas usage habit.

In this embodiment of the present invention, each of the management sub-platform 30 may further update a gas usage model of a corresponding gas meter in real time or at intervals according to a current gas usage record of the corresponding gas meter. In addition, when a current gas price changes, the gas amounts purchased by a same price before and after the change are different, so each of the management sub-platforms 30 may further update a gas usage model of a gas meter according to the current gas price when the gas price changes.

Step S105, the service platform 40 sends a first gas remaining amount and a first gas usage time limit of each of the gas meters to the user platform 50.

After each of the management sub-platforms 30 sends a first gas remaining amount and a first gas usage time limit of a corresponding gas meter to the service platform 40, the service platform 40 forwards a first gas remaining amount and a first gas usage time limit of each of the gas meters to the user platform 50. In this way, after the successful recharging, a user who recharges at the user platform 50 may know a purchased gas remaining amount and a time limit within which the gas remaining amount can be used normally, so that the user can repurchase the gas before the purchased gas is used up and a condition in which the gas is stopped suddenly because the purchased gas is used up in the process of gas usage of the user is effectively prevented, thereby facilitating the daily life of the user and improving the user experience.

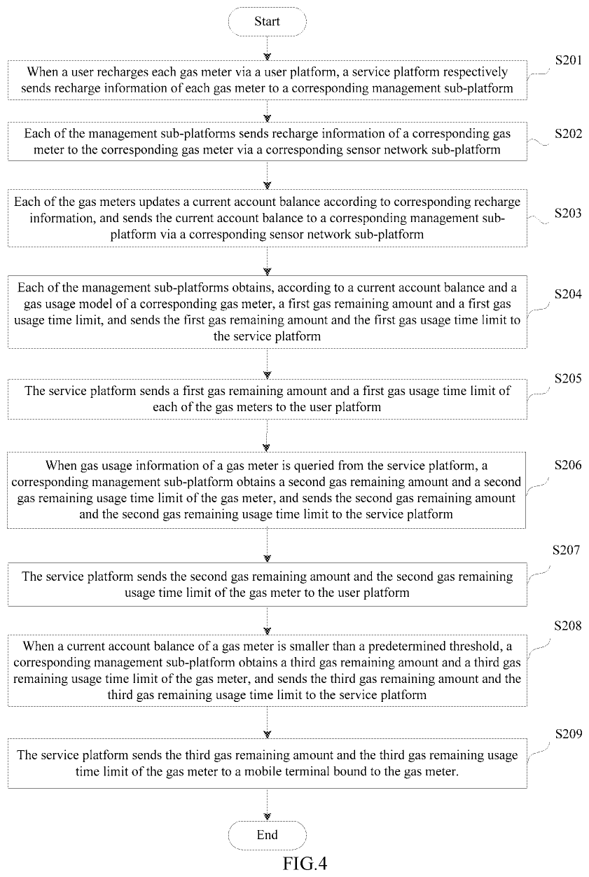

See FIG. 4, which illustrates a flowchart of another gas usage time limit pushing method based on a compound IoT provided by a preferred embodiment of the present invention. The process shown in FIG. 4 is described below in detail.

Step S201, when a user recharges each gas meter via a user platform 50, a service platform 40 respectively sends recharge information of each gas meter to a corresponding management sub-platform 30.

Step S202, each of the management sub-platforms 30 sends recharge information of a corresponding gas meter to the corresponding gas meter via a corresponding sensor network sub-platform 20.

Step S203, each of the gas meters updates a current account balance according to corresponding recharge information, and sends the current account balance to a corresponding management sub-platform 30 via a corresponding sensor network sub-platform 20.

Step S204, each of the management sub-platforms 30 obtains, according to a current account balance and a gas usage model of a corresponding gas meter, a first gas remaining amount and a first gas usage time limit, and sends the first gas remaining amount and the first gas usage time limit to a service platform.

Step S205, the service platform 40 sends a first gas remaining amount and a first gas usage time limit of each of the gas meters to the user platform 50.

Step S206, when gas usage information of a gas meter is queried from the service platform 40, a corresponding management sub-platform 30 obtains a second gas remaining amount and a second gas remaining usage time limit of the gas meter, and sends the second gas remaining amount and the second gas remaining usage time limit to the service platform 40.

In the process of the gas usage, a user may query gas usage information of a gas meter from the service platform 40 via the user platform 50 at any time. At this moment, the service platform 40 sends a query request to a management sub-platform 30 corresponding to the gas meter to be queried, and the management sub-platform 30 obtains a second gas remaining amount of the gas meter according to a current account balance of the gas meter to be queried and a current gas price.

Meanwhile, the management sub-platform 30 estimates, according to the second gas remaining amount and a gas usage model of the gas meter, a second gas usage time limit of the gas meter, and then sends the second gas remaining amount and the second gas remaining usage time limit of the gas meter to the service platform 40.

Step S207, the service platform 40 sends the second gas remaining amount and the second gas remaining usage time limit of the gas meter to the user platform 50.

After the management sub-platform 30 sends the second gas remaining amount and the second gas usage time limit of the gas meter to the service platform 40, the service platform 40 sends the second gas remaining amount and the second gas usage time limit of the gas meter to the user platform 50. In this way, it is very convenient to query a gas remaining amount purchased by a user and a time limit within which the gas remaining amount can be used normally, and thus the user can repurchase the gas before the purchased gas is used up.

Step S208, when a current account balance of a gas meter is smaller than a predetermined threshold, a corresponding management sub-platform 30 obtains a third gas remaining amount and a third gas remaining usage time limit of the gas meter, and sends the third gas remaining amount and the third gas remaining usage time limit to the service platform 40.

In this embodiment of the present invention, each management sub-platform 30 may be provided with a threshold for characterizing whether or not a current balance of a gas meter is too low. If the current balance of the gas meter is smaller than the threshold, it is indicated that the balance of the gas meter is too low at this moment, and the purchased gas will be used up soon. In this case, a management sub-platform 30 corresponding to the gas meter obtains a third gas remaining amount of the gas meter according to the current account balance of the gas meter, estimates a third gas remaining usage time limit of the gas meter according to the third gas remaining amount and a gas usage model of the gas meter, and sends the third gas remaining amount and the third gas remaining usage time limit of the gas meter to the service platform 40.

Step S209, the service platform 40 sends the third gas remaining amount and the third gas remaining usage time limit of the gas meter to a mobile terminal bound to the gas meter.

In this embodiment of the present invention, each gas meter may be bound to one or more mobile terminals, and the information of the bound mobile terminals is stored to the service platform 40. Each mobile terminal may be a mobile phone, and the information of the mobile terminal may be a phone number of the mobile phone.

After the management sub-platform 30 sends the third gas remaining amount and the third gas usage time limit of the gas meter to the service platform 40, the service platform 40 sends the third gas remaining amount and third gas usage information of the gas meter in a manner of a short message to a mobile terminal bound to the gas meter. In this way, when the purchased gas of each gas meter is to be used up soon, a user may be directly reminded in the manner of the short message, so that the user can repurchase the gas before the purchased gas is used up and a condition in which the gas is stopped suddenly because the purchased gas is used up in the process of gas usage of the user is effectively prevented, thereby facilitating the daily life of the user and improving the user experience.

In conclusion, according to the gas usage time limit pushing method based on the compound IoT and the IoT system provided by this embodiment of the present invention, after a user purchases the gas at each time, a usage time limit for the purchased gas of the user can be estimated and is sent to the user platform 50 to remind the user, so that the user can repurchase the gas before the purchased gas is used up and a condition in which the gas is stopped suddenly because the purchased gas is used up in the process of gas usage of the user is effectively prevented, thereby facilitating the daily life of the user and improving the user experience. At the same time, the user can check a purchased gas remaining amount and a time limit within which the gas remaining amount can be used normally at the user platform 50 at any time. In addition, when the purchased gas of each gas meter is to be used up soon, the user may be reminded automatically via the service platform 40 in a manner of the short message, so that the user can repurchase the gas before the purchased gas is used up, thereby further facilitating the daily life of the user and improving the user experience. With the gas usage time limit pushing method based on the compound IoT and the IoT system provided by this embodiment of the present invention, a condition in which the gas is stopped suddenly because the purchased gas is used up in the process of gas usage of the user can be effectively prevented, thereby facilitating the daily life of the user and improving the user experience.

In several embodiments provided by the present application, it should be understood that the disclosed apparatus and method may also be implemented in other manners. The described apparatus embodiments are merely exemplary. For example, the flowcharts and block diagrams in the drawings illustrate the system architecture, function, and operation of possible implementations of apparatuses, methods, and computer program products according to various embodiments of the present invention. In this regard, each block in the flowcharts or block diagrams may represent a module, program segment, or portion of code, which includes one or more executable instructions for implementing the specified logical function(s). It should also be noted that in some alternative implementation manners, the functions noted in the block may occur out of the sequence noted in the drawings. For example, two continuous blocks, in fact, may be executed concurrently, or in a reverse order, which will depend upon the functions involved. It will also be noted that each block of the block diagrams and/or flowcharts, and combinations of blocks in the block diagrams and/or flowcharts, may be implemented by a special hardware-based IoT system that performs the specified functions or acts, or by using combinations of special hardware and computer instructions.

In addition, each module in the embodiments of the present invention may exist independently, and two or more modules may be integrated into an independent part.

When a function is implemented in the form of the software functional unit and sold or used as a separate product, the function may be stored in a computer readable storage medium. Based on such understanding, the technical solutions of the present invention or the part that makes contributions to the prior art or a part of the technical solutions may be substantially embodied in a form of a software product. The computer software product is stored in a storage medium, and includes several instructions to instruct a computer device (which may be a personal computer, server, network device, or the like) to execute all or some steps of the methods described in the embodiments of the present invention. The foregoing storage medium includes: various media capable of storing a program code, such as a disk, a mobile hard disk, a Read-Only Memory (ROM), a Random Access Memory (RAM), a magnetic disk or an optical disk. It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

The foregoing descriptions are merely specific implementation manners of the present invention, but are not intended to limit a scope of protection of the present invention. Any variation or replacement readily figured out by a person skilled in the art within the technical scope disclosed in the present invention shall fall within the scope of protection of the present invention. Therefore, the scope of protection of the present invention shall be subject to the scope of protection of the claims.

It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

What is claimed is:

1. A gas usage time limit pushing method based on a compound Internet of Things (IoT), wherein the method is applied to an IoT system; the IoT system comprises a plurality of object sub-platforms, a plurality of sensor network sub-platforms, a plurality of management sub-platforms, a service platform and a user platform; each of the object sub-platforms comprises a gas meter; each of the sensor network sub-platforms comprises an IoT intelligent gateway; the management sub-platforms comprise a gas company management server; and the method comprises:
when a user recharges each gas meter via the user platform, respectively sending, by the service platform, recharge information of each gas meter to a corresponding management sub-platform;
sending, by each of the management sub-platforms, recharge information of a corresponding gas meter to the corresponding gas meter via a corresponding sensor network sub-platform;
updating, by each of the gas meters, a current account balance according to corresponding recharge information, and sending the current account balance to a corresponding management sub-platform via a corresponding sensor network sub-platform;
respectively obtaining, by each of the management sub-platforms, according to a current account balance and a gas usage model of a corresponding gas meter, a first gas remaining amount and a first gas usage time limit of the corresponding gas meter, and sending the first gas remaining amount and the first gas usage time limit of the corresponding gas meter to the service platform; and
sending, by the service platform, a first gas remaining amount and a first gas usage time limit of each of the gas meters to the user platform.

2. The gas usage time limit pushing method based on the compound IoT according to claim 1, wherein the method further comprises:
when the user platform queries gas usage information of any gas meter from the service platform, obtaining, by a management sub-platform corresponding to the gas meter, a second gas remaining amount of the gas meter according to a current account balance of the gas meter, estimating a second gas remaining usage time limit of the gas meter according to a gas usage model of the gas meter, and sending the second gas remaining amount and the second gas remaining usage time limit of the gas meter to the service platform; and
sending, by the service platform, the second gas remaining amount and the second gas remaining usage time limit of the gas meter to the user platform.

3. The gas usage time limit pushing method based on the compound IoT according to claim 1, wherein the method further comprises:
when a current account balance of a gas meter is smaller than a predetermined threshold, obtaining, by a management sub-platform corresponding to the gas meter, a third gas remaining amount of the gas meter according to a current account balance, estimating a third gas remaining usage time limit of the gas meter according to a gas usage model of the gas meter, and sending the third gas remaining amount and the third gas remaining usage time limit of the gas meter to the service platform; and
sending, by the service platform, the third gas remaining amount and the third gas remaining usage time limit of the gas meter to a mobile terminal bound to the gas meter.

4. The gas usage time limit pushing method based on the compound IoT according to claim 1, wherein the method further comprises:
updating, by each of the management sub-platforms, according to a current gas usage record of a corresponding gas meter, a gas usage model of the gas meter.

5. The gas usage time limit pushing method based on the compound IoT according to claim 1, wherein the method further comprises:
when a current gas price changes, updating, by each of the management sub-platforms, a gas usage model of a gas meter according to the current gas price.

6. An Internet of Things (IoT) system, wherein the IoT system comprises a plurality of object sub-platforms, a plurality of sensor network sub-platforms, a plurality of management sub-platforms, a service platform and a user platform;
when a user recharges each gas meter via the user platform, the service platform respectively sends recharge information of each gas meter to a corresponding management sub-platform;
each of the management sub-platforms sends recharge information of a corresponding gas meter to the corresponding gas meter via a corresponding sensor network sub-platform;
each of the gas meters updates a current account balance according to corresponding recharge information, and sends the current account balance to a corresponding management sub-platform via a corresponding sensor network sub-platform;
each of the management sub-platforms respectively obtains, according to a current account balance and a gas usage model of a corresponding gas meter, a first gas remaining amount and a first gas usage time limit of the corresponding gas meter, and sends the first gas remaining amount and the first gas usage time limit of the corresponding gas meter to the service platform; and
the service platform sends a first gas remaining amount and a first gas usage time limit of each of the gas meters to the user platform.

7. The IoT system according to claim 6, wherein when the user platform queries gas usage information of any gas meter from the service platform, a management sub-platform corresponding to the gas meter obtains a second gas remaining amount of the gas meter according to a current account balance of the gas meter, estimates a second gas remaining usage time limit of the gas meter according to a gas usage model of the gas meter, and sends the second gas remaining amount and the second gas remaining usage time limit of the gas meter to the service platform; and
the service platform sends the second gas remaining amount and the second gas remaining usage time limit of the gas meter to the user platform.

8. The IoT system according to claim 6, wherein when a current account balance of a gas meter is smaller than a predetermined threshold, a management sub-platform corresponding to the gas meter obtains a third gas remaining amount of the gas meter according to a current account balance, estimates a third gas remaining usage time limit of the gas meter according to a gas usage model of the gas meter, and sends the third gas remaining amount and the third gas remaining usage time limit of the gas meter to the service platform; and
the service platform sends the third gas remaining amount and the third gas remaining usage time limit of the gas meter to a mobile terminal bound to the gas meter.

9. The IoT system according to claim 6, wherein each of the management sub-platforms updates, according to a current gas usage record of a corresponding gas meter, a gas usage model of the gas meter.

10. The IoT system according to claim 6, wherein when a current gas price changes, each of the management sub-platforms updates a gas usage model of a gas meter according to the current gas price.
